(19) United States
(12) Patent Application Publication
(10) Pub. No.: US 2002/0148939 A1
(43) Pub. Date: Oct. 17, 2002

(54) Combination mouse pad with integrated writing pad holder

(76) Inventor: Thomas D. Adams, Campo, CA (US)

Correspondence Address: PAGE LOHR ASSOCIATES, PO BOX 757, LA JOLLA, CA, 92038, US

(21) Appl. No.: 09/834,058

(22) Filed: Apr. 12, 2001

(51) Int. Cl. B68G 5/00

(52) U.S. Cl. 248/346.01; 248/918; 248/118; 281/2

(57) ABSTRACT

These inventions are generally concerned with computer accessory devices and more particularly directed to a combination device including a mouse pad element with integrated writing pad holder and writing instrument holder or holders. These inventions include combinations of a mouse pad and a writing pad whereby a user is afforded easy access to the writing work surface as well as the mouse working surface. The total work area used is only slightly larger than a conventional mouse pad thus obviating the need for a separate writing station. A simple substrate of material forms a base including mouse pad working surface. A raised ridge forms a receiving cavity into which a writing pad may be placed and held. The raised ridge may be arranged in one of four corners of a rectangular mouse pad. The ridge may also be arranged to accommodate special features relating to the supported tasks, i.e. writing and operating a mouse, such as the feature of providing a pen holding means. Other important features include a visually attractive device with support for a graphical printing which cooperates with the overall geometry of the devices.

### BACKGROUND OF THE INVENTION

1. Field

The following invention disclosure is generally concerned with computer accessory devices and specifically concerned with a combination mouse pad with integrated note pad.

2. Prior Art

Several attempts in the art address the need of providing hand writing activity in conjunction with pointing actions via computer periphery device or ‘mouse’. These systems and designs generally incorporate schemes whereby an entire writing sheet also serves as the mouse traction surface. Some inventor employ specialized papers which serve the writing purpose as well as the mouse purpose. Others, use cover sheet materials which allow writing pads to be stored thereunder. In neither of the inventions can one find a system which allows the two functions, i.e. hand writing and mouse operability, to be closely brought together in the same unit thereby providing easy of use and great efficiency when these two functions are use together. Detailed examples of the art follow.

U.S. Pat. No. 5,971,340 to inventor Murphy combines a mouse pad with a note pad which may be written on with a pen. The entire surface of the note pad is used for both writing notes by hand and for rolling a computer mouse thereover. Sheets torn away from the pad leave a fresh surface for further writing and a surface which similarly allows a mouse to be operated thereon. After all of the sheets in the pad are used, an entire new pad becomes necessary as the device in its entirety is a consumable product. As most common types of paper do not support the rolling properties of a mouse track ball, the pad is required to be made of sheets of paper which have specialized properties. These pads are therefore more expensive and difficult to make. Further, the inks and graphites from which writings are comprised can cause trouble with the mouse works. Inks collect on the track ball and may be further transferred into the inner mechanisms of the device polluting it and causing it to malfunction.

Similar U.S. Pat. No. 5,876,010 contains most or all of the features of the above-identified patent. Its uses and functionality are also similar.

Inventor Holt of U.S. Pat. No. 5,405,168 teaches of a mouse pad and note pad combination. A pad of paper having a special texture sometimes known as ‘cotton laid’ paper provides a superior surface for both clearly writing notes and operation of the mouse track ball. The pad of paper is arranged with attention to avoiding damaging the mouse device with adhesives used to form the pad of paper sheets. However, Holt like others has the problem of inks which tend to collect on and in the mouse device and damage its workings.

A specialized organizer device includes a work surface information display pad taught in U.S. Pat. No. 5,022,170. The device includes a pad for covering a work surface which may be translucent or transparent. The pad is said to provide a textured surface which may be written to or to provide a work surface upon which a mouse may be operated. In this way, the actions relating to hand writing and mouse activity are supported in the single device.

U.S. Pat. No. 5,490,710 relates to an appliance which may be used in conjunction with a chair and more particularly the arm of a chair. A pivoting writing table includes direct incorporation of a mouse pad thereon. The table pivots from a horizontal position to a vertical position to allows users to enter and exit the chair. The table may support activity such as writing to a note pad which may be placed thereon the folding table. The folding table does not support a writing pad in close proximity with a mouse working surface and address more directly a moving table to allow users access to a chair.

A lap pad container taught in U.S. Pat. No. 6,062,522 includes means for improving the operation of a mouse device therewith. In addition, the device supports other activity which may relate to use of a computer by way of a mouse. The disclosure specifically address writing notes with the confines of the device. It also points out that activity such as cutting vegetables and playing cards is enabled in view of the arrangements presented.

Inventor Nielsen U.S. Pat. No. 6,158,829 in newly granted patent, Dec. 12, 2000, presents a workstation comprising a keyboard enclosure and a work surface. The work surface supports both a writing area and an area arranged for the operation of a computer periphery such as a mouse. Further, storage trays for pens, paperclips and other office tools is included.

U.S. Pat. No. 5,217,781 issued to Mr. Kuipers of the Netherlands includes a computer mouse pad composed of a plurality of special layers. A non static layer of polyvinal chloride, a crease resistant intermediate layer, and anti slip layer form a pad for operation of a computer mouse.

A patent entitled “Computer Workplace Organizer” is U.S. Pat. No. 5,598,921 issued to Mr. Hunt of California. The organizer consists of a plurality of elements and configurations to support activity including writing upon a note pad and operation of a computer mouse.

An organizing folder of U.S. Pat. No. 5,732,976 combines computer related functionality with note pad operation.

An electronic notepad which supports activity relating to both mouse and writing properties is taught in U.S. Pat. No. 5,995,084 to inventor Chan et al.

While the systems and inventions of the art are designed to achieve particular goals and objectives, some of those being no less than remarkable, these inventions have limitations which prevent their use in new ways now possible. These art inventions of the art are not used and cannot be used to realize the advantages and objectives of the present invention.

### SUMMARY OF THE INVENTION

Comes now, Thomas D. Adams with an invention of a mouse pad and writing pad combination including devices whereby related functions are integrated together and supported in a single device.

The invention includes a combination of a mouse pad and a writing pad whereby a user is afforded easy access to the writing work surface as well as the mouse working surface. More particularly, the mouse and writing pad including a pen, may be operated with a single hand, for example ones right hand. The total surface area used is no greater, or only slightly greater, than a conventional mouse pad.

Devices of these inventions are basically formed of two major elements. A simple substrate of material forms a base including mouse pad working surface. A raised ridge forms a receiving cavity into which a writing pad may be placed and held. The raised ridge may be arranged in one of four corners of a rectangular mouse pad. The raised ridge preferably is arranged to form a cavity of between 2 and 3 inches on a side. The raised ridge may be a quarter inch deep to accommodate pads of many sheets. The raised ridge may be affixed to the mouse pad substrate by glue or other adhesives. The ridge may be formed of the same material from which the substrate is formed; indeed, they may even be formed together in a molding process. The ridge may also be arranged to accommodate special features relating to the supported tasks, i.e. writing and operating a mouse, such as the feature of providing a pen holding means. Finally, it is an important feature to provide a visually attractive device with support for a graphical printing which cooperates with the overall geometry of the devices.

### OBJECTIVES OF THE INVENTION

It is a primary object of the invention to provide a combination mouse pad and writing pad holder.

It is an object of the invention to provide a mouse pad and writing pad holder integrated together as a single device.

It is a further object to provide a writing station apparatus which cooperates in space with a computer peripheral device known as a ‘mouse’.

It is an object of the invention to provide a multi-functional instrument which simultaneously supports mouse actions and writing actions.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by the claims, but do not appear here as specific examples. It will be appreciated that a great plurality of alternative versions are possible.

### BRIEF DESCRIPTION OF THE DRAWING FIGURES

These and other features, aspects, and advantages of the present invention will become better understood with regard to the following description, appended claims and drawings where:

FIG. 1 illustrates a simplistic front-on two dimensional view of a device of the invention;

FIG. 2 is an illustration of a device accompanied by attractive indicia and a writing pad held within a writing pad receiving cavity of the device;

FIG. 3 shows a device of the invention in a specialized perspective view drawing including a three dimensional representation of features of the device;

FIG. 4 similarly shows a device in perspective and further illustrates the device engaged by a computer mouse and a writing pad;

FIG. 5 illustrates a special advantage afforded by arrangements taught herein; and

FIG. 6 is a final illustration which shows a device further engaged by a pen.

### GLOSSARY OF SPECIAL TERMS

Throughout this disclosure, reference is made to some terms which may or may not be exactly defined in popular dictionaries as they are defined here. To provide a more precise disclosure, the following terms are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within the pertinent arts or by dictionary meaning. Where the presented definition is in conflict with a dictionary or arts definition, one must use the context of use and liberal discretion to arrive at an intended meaning. One will be well advised to error on the side of attaching broader meanings to terms used in order to fully appreciate the depth of the teaching and to understand all the intended variations.

Substrate

For purposes of this disclosure a ‘substrate’ is a slab of material having a periphery and two sides. Upon the substrate, structure may be formed and arranged to arrive at a complete device.

Working Surface

A ‘working surface’ is a substrate surface arranged in a fashion to support a particular function associated with the device.

Receiving Cavity

Although a cavity may be mere space and not any comprised of physical material, it is an construct used herein to refer to a space of significant importance. A ‘receiving cavity’ is arranged to receive and hold therein physical objects which relate to operation of the entire device.

Writing Pad

A ‘writing pad’ is a consumable product comprising a plurality of sheets of paper.

Mouse Pad

A ‘mouse pad’ is a substrate having a special surface upon which a computer peripheral device herein known as a ‘mouse’ operates.

Raised Ridge

A ‘raised ridge’ is used to form a writing pad receiving cavity or writing pad holding element.

Pen Holder Hole

A ‘pen holding hole’ is a hole arranged in size and position to support the function of holding a pen therein.

### PREFERRED EMBODIMENTS OF THE INVENTION

In accordance with each of the preferred embodiments of the invention, there is provided apparatus formed as a combination mouse pad and note pad. It will be appreciated that each of the embodiments described include an apparatus and that the apparatus of one preferred embodiment may be different than the apparatus of another embodiment.

While using a computer peripheral device known as a mouse, one frequently finds the need to make written notes. A sales agent, while scrolling through the records of a database, may find information to be noted and used in another part of an application running on a computer. The information displayed at the computers terminal may be transferred to a writing pad in a manual step.

To accomplish this easily and efficiently, the computer mouse and the writing pen, both generally operated by the same hand, should be very near each other to save time and effort. If one should be required to lean the body forward to grab a pen and then further be required to lean to a writing pad each time written information is to be taken from the display screen, one is burdened with unnecessary efforts. A mouse pad and writing pad in combination may be formed whereby they are a single device which allows a single hand to operate both the mouse and the writing task.

A mouse pad is generally less than 100 square inches in surface area. Although many materials are compatible with the rolling track ball of a mouse, one which has gained considerable favor amongst users is the slab of blown rubber material more commonly known as and sold under the trademark “Neoprene”. A rectangularity shaped neoprene substrate provides and ideal surface upon which a computer mouse may be operated with ease and efficiency.

Although writing pads come in many shapes and sizes, one special writing pad which has gained considerable popularity of late includes those which are square in shape and are about 2.5 to 3 inches on a side. In particular those produced by the Minnesota Mineral and Mining company, otherwise known as the 3M company, and commonly sold under the trademark “Post-It”® notes. These writing pads are characterized by their very useful adhesive material which holds many sheets together while providing a reusable sticking means which allows one to place notes in useful places, remove the notes, and further place them in new locations.

One important advantage of the preferred arrangements taught herein is that the writing plane is very close to the plane in which mouse is operated. On the surface this may not seem important, however, tests show that a reduction in time to switch between tasks is accompanied by arrangements where the working planes are the same or similar. This is believed to be due to fact that the hand muscles quickly perform when the arm is not required to first adjust position to a new workspace.

It is also part of natural writing that the heal of the palm rest in a plane where the paper lies. Further to this point, it is therefore a distinct advantage to have the writing pad plane near as possible to mouse plane. Since the writing pad is necessarily quite small, the mouse plane is used during writing operations as a rest for the heal of the writing hand which is set upon the mouse pad working surface.

Another important advantage is a single mouse pad is usable in an ambidextrous fashion. When a separate pen holding hole is put into each of two receiving cavity sides which extend inwardly, the resulting symmetry allows one to rotate the pad by 90 degrees to achieve operation in a direction which cooperates with ergonomics of left-handed persons. Further details as to the location of pen holding holes in the raised ridge can be more fully appreciated in the drawing figures presented in greater detail hereafter.

Devices of these inventions are comprised of two major elements which may be integrated together as one. A first element is a substrate element having two surfaces and a periphery. Each of the two surfaces has associated therewith a particular function. There surfaces are on opposite sides of the substrate. Particular features of the substrate element are devised and arranged to meet requirements particular to the combination of a mouse pad and a writing pad. These will become apparent in view of the following details.

The material used to make up the substrate should be durable, flexible, washable, and printable. It may be cloth or plastic or rubber. The two sides of the substrate include two different surfaces. The top surface is a working surface for mouse activity and the bottom surface is provided with special non-skid functionality.

The top surface must cooperate with the track ball portion of a computer mouse. It must be clean and provide good rolling action for the mouse which is moved across the surface. In addition, certain versions enjoy the added benefit of having thereon printed matter. From the drawing figures, one will notice an company logo for the NU-BREATH Inc. company printed on the top surface of the substrate. Although the “NU-BREATH” logo is very attractive, it certainly is not the only logo which would make the device have a pleasing appearance. Indeed, other company logos would make a handsome looking mouse pad. In particular, where the visual effect yields a pleasing cooperation between the writing pad and the well placed indicia to form a graphical balance. Themes may be printed as well. For example, cartoon characters and other theme related matter will become popular with persons who use these devices.

The bottom surface of these substrates should include a non-skid function. While non-skid is important for normal mouse pad devices, the need for non-skid is heighten in view of present inventions. This is due to the fact that the added writing activity to be done on these pads will demand improved performance of the non-skid bottom surface.

The substrate portion of devices of these inventions have very unique asymmetric peripheries. Because a mouse pad and writing pad holder are combined as one device, conservation of space is critical. While most mouse pads have four rounded corners, preferred configurations taught here demand that the raised ridge portion be pushed as far into the upper corner of the substrate as possible to allow greater space for the mouse operations. This condition suggests the upper left corner be made with a right angle to better accommodate the raised ridge of a similar shape. While strictly speaking, one might make writing pads of a rounded corner, and further receiving cavities of rounded corner to match, this alternative is not view as a best mode because it requires specially shaped writing pads. It is pointed out that this configuration is still believed to be part of the invention, however better modes are delivered here as examples.

A second element is a raised ridge element. A raised ridge element is a structural element arranged to form a receiving cavity which cooperates with a writing pad. Particular features of the raised ridge element are devised and arranged to meet requirements particular to the combination of a mouse pad and a writing pad. These features will become apparent in full view of the following specifics.

The raised ridge element forms a receiving cavity which is substantially smaller in size than said area of the substrate element. A raised ridge element preferably has at least three sides and is disposed in one of the four substrate corners. It may be affixed to the corner whereby the receiving cavity is formed and delimited by a portion of the substrate top surface and sides of the raised ridge element. The receiving cavity is thereafter operable for receiving and holding therein a pad of writing paper.

In best versions, the raised ridge is comprised of four edges, two of which are parallel to each other and perpendicular to the other two. To of the four edges are aligned and colinear with the substrate edges. This can be fully appreciated in view of the drawing figures details hereafter. Two of the four raised ridge edges extend inwardly away from the substrate edges towards the interior of the top surface of the substrate.

In some preferred versions, it is best to make one of the inwardly extending sides greater in length, or about twice the length than the other. The side extending downwardly may be shorted than the one extending in from the substrate side. In this way, a open region is formed which allows one to easily grab the corners of sheets of paper in a writing pad.

The two major elements may be formed separately and integrated together with adhesives or alternative fastening means. Alternatively, a single mold of complex geometry may be made to accommodate the entire shape of the devices. Blown rubber set into the mold then forms both the substrate portion and the raised ridge portion. Complexities relating to the various surface materials used may not support surfaces which do not lie in a single plane. Accordingly, a two piece construction whereby the parts are joined together is a post process is anticipated as being a preferred mode of construction.

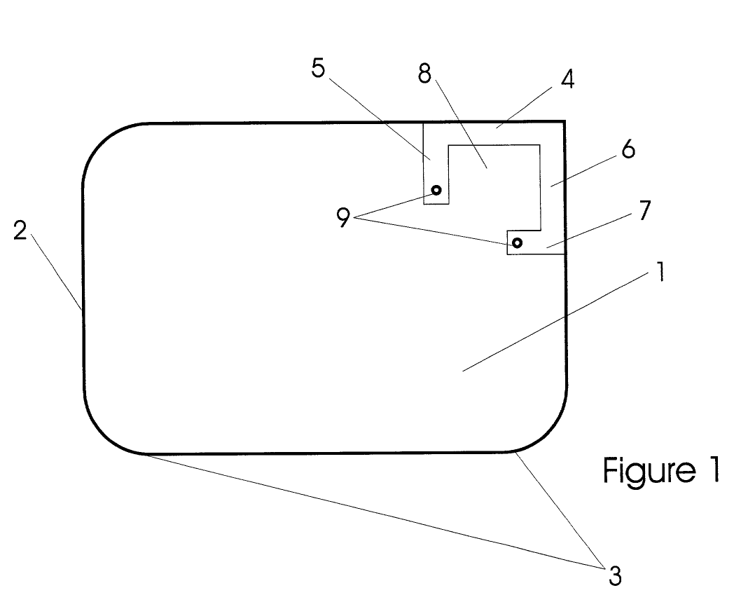

With regard to the drawing figures, the reader will gain a more full understanding of preferred versions of these inventions. The first figure, FIG. 1, is a front-on drawing of two dimensions which shows a device in simplest line diagram form. Reference numerals are used to direct attention to the most important parts of the devices as follows. The main body or substrate portion of the device is depicted as 1. The substrate has a front and back surface and a periphery. The front surface is shown in the drawing figure and the back surface is hidden from view. The periphery of the substrate is partly comprised of an edge 2 of the substrate and rounded corners 3. A raised ridge 4 portion of the device comprises ridge side elements 5 and 6 and further side element 7. Together, these side elements of the raised ridge form a receiving cavity 8 in which a writing or note pad may be quite functionally accommodated. The ridge is called a ‘raised’ ridge because it is raised from the plane of the top surface of the substrate. The raised ridge is preferably set in the upper left corner of the mouse pad and two of its sides share an edge with the substrate edge as shown. The surface area of the substrate is typically five to ten times the size of the surface area enclosed by the sides of the raised ridge. The raised ridge may further include specially arranged holes 9 fashioned to cooperate with the tips of ball point type writing pens which may be placed therein for temporary storage.

The careful observer will notice that the raised ridge is made of two sides which share an edge with the main substrate and two sides which extend inwardly with respect to the substrate edge. Raised ridge sides denoted as 5 and 7 extend inwardly. However, side 5 is drawn to be twice the length as side 7. This arrangement provides very special function. Since a writing pad comprised of a great plurality of sheets is most frequently bound at its top, the free edge of the pad is at its bottom. To most easily peel away the top sheet, one must grab the bottom edge of the paper sheet on the top of the pad. Thus, it is with purpose that more of the bottom edge of sheet is exposed than the side edge of the sheet, to facilitate removal of a sheet from the writing pad.

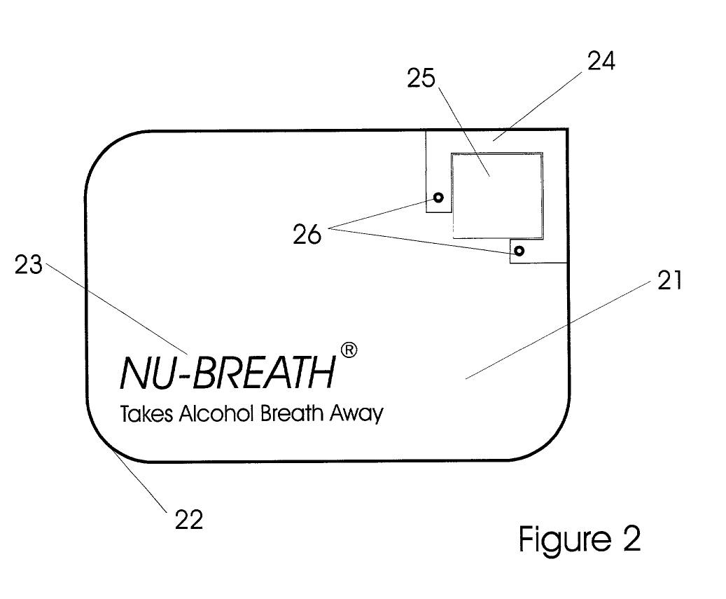

FIG. 2 shows a similar two dimensional drawing which further illustrates important function of devices of the invention as an example device is shown in conjunction with and engaged by two important ancillary objects. A writing pad of paper and special well placed indicia which cooperates with the position of the writing pad to form a visually pleasing balance. Substrate 21 which may be a thin sheet of Neoprene; for example a quarter of an inch thick. Although generally rectangular, the substrate may be formed with three rounded corners and a single right angle or ‘square’ corner. A rounded corner is illustrated as element 22. Because preferred writing pads have square corners and it is desirable to conserve as much usable space as possible on the substrate for mouse moving activity, the upper right hand corner is made square to further accommodate the raised ridge which has square corners. Accordingly, preferred versions of the invention have three rounded corners and a square corner upon which the raised ridge is set. This is a very important element which adds to the overall cooperation between a mouse pad and a writing pad holder. Indicia 23 which may be silk screen printed on the top or working surface of the substrate can support advertising and vanity functionality. Company logos and other attractive graphics including themes of interest or collector series images, et cetera, may be supported. This indicia operates closely with the position of the writing pad receiving cavity to form a balance. Each of two opposite corners of the mouse pad being occupied with an asymmetric object form a pleasing look which is well balanced. The receiving cavity is formed by raised ridge 24 such that a writing pad of paper 25, for example, 2.5 inch Post-It notes, is accompanied therein the receiving cavity. One can easily see how the bottom edge of the pad is exposed and the exposure favors the bottom edge over the side edge of the sheets in the pad. Finally, pen holding holes 26 are formed symmetrically into the middle of the raised ridge sides which extend inward.

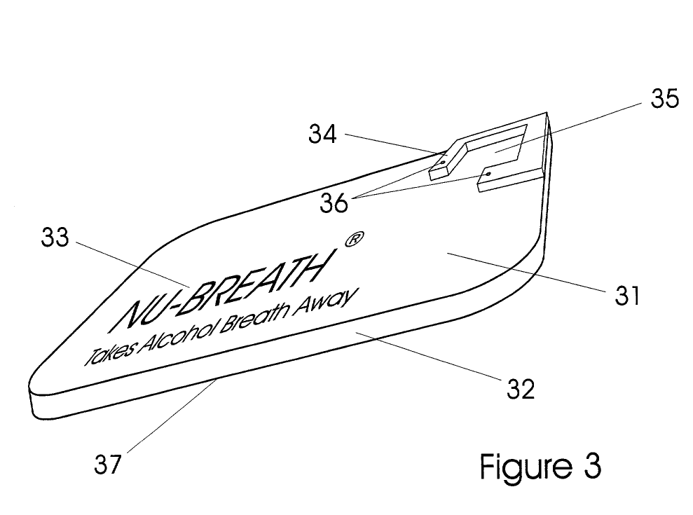

FIG. 3 is a three dimensional perspective view drawing of a preferred version of a device of the invention. A neoprene substrate 31 which may be roughly 0.25 inches in thickness 32 is shown with a raised ridge element upon its top or working surface. Ink printed logo “NU-BREATH” 33 appears in the lower left corner of the device. Although the “NU-BREATH” logo is very attractive, it certainly is not the only logo which would make the device have a pleasing appearance. Raised ridge 34 is very nicely shown in three dimensions to clearly illustrate the space which comprises the writing pad receiving cavity 35. The raised ridge may have an additional feature to provide a pen holding function. Holes may be formed into the raised ridge which operate to hold a pen which has been pushed therein. The intrinsic resilient nature of neoprene causes the material to hold a pen tip with good security and long lasting life. As is common in mouse pads made from neoprene, the bottom surface 37 of the substrate is a rubbery, sticky medium which promote a non-skid function. While non-skid is useful in common mouse pads, it is particularly useful in pads such as those taught here because writing actions tend to put increased lateral loads on the mouse pad which would otherwise tend to cause it to slide about a table upon which it rests.

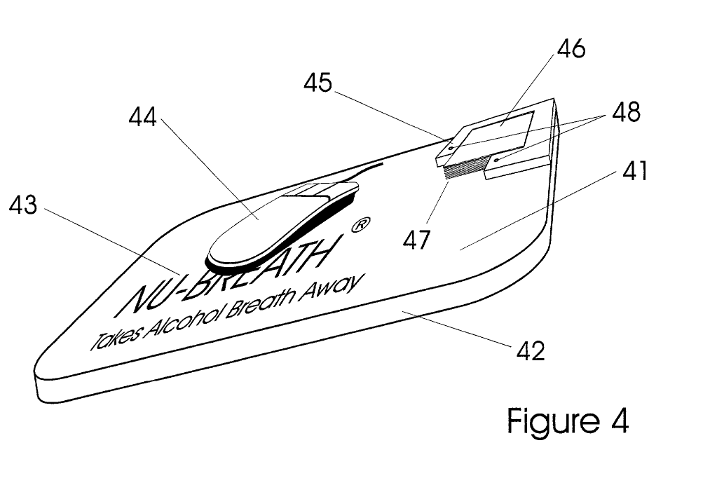

FIG. 4 is a similar perspective drawing which shows a device of the invention in conjunction with a writing pad and a mouse. The top surface 41 of a slab of neoprene having a thickness 42 and company logo indicia 43 has a mouse type computer peripheral device 44 thereon. The top surface of the neoprene is ideal for operation of the mouse's track ball which is encouraged to roll smoothly as the mouse is moved about. Raised ridge 45 forms a rectangular cavity into which a writing pad 46 may be well received. The arrangement is quite special as the lower left corners of the sheets from which the writing pad is comprised are exposed permitting free access thereto in region 47, while at the same time the writing pad is held quite securely in the cavity. Pen holder holes 48 are illustrated in the drawing as ideally located in the raised ridge near the endpoints of the raised ridge sides which extend inwardly away from the substrate sides. Although the writing pad and mouse are shown in the drawing, one is reminded that those objects are not part of the apparatus. Rather, the apparatus is formed of a mouse pad and writing pad holder integrated as one. The drawing includes the mouse and writing pad to illustrate interaction between devices of the invention and those to which it relates.

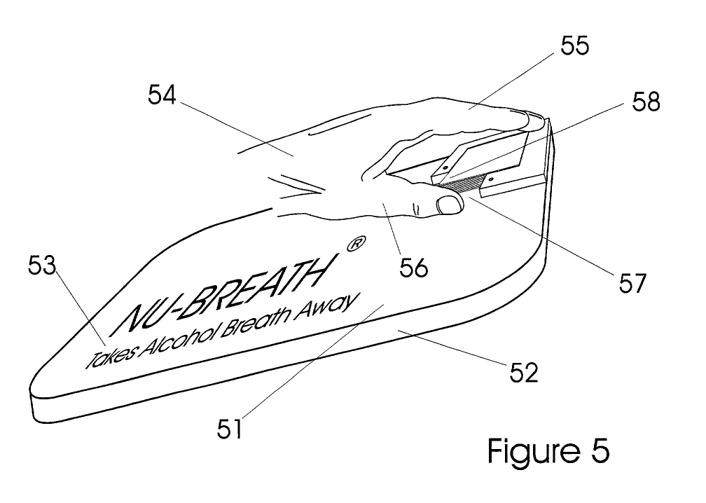

FIG. 5 is an important illustration to show access to individual sheets of the writing pad. Mouse pad 51 made of quarter inch neoprene 52 having ‘NU-BREATH’ company logo 53 silk screened thereon holds a writing pad within its receiving cavity. A human hand 54 is illustrated as taking a sheet from the pad. Forefinger 55 and thumb 56 in a region without a raised ridge 57, together operate to easily access the sheets at the exposed corner 58 and to separate a single sheet from the stack of sheets. It is easy to understand that the writing pad is quite accessible while the mouse pad remains totally functional. In this way, one can efficiently perform mouse moving activities and note writing activities in the same workspace. It is no longer necessary for one to have a separate writing station which consumes a great amount of desk top and a separate mouse working surface. These two common desktop elements can be combined as one in consideration of the concept presented herein. As a combination, the device promotes great advantages which are easily recognized by those experts who use a mouse while being required to take notes in the same workplace.

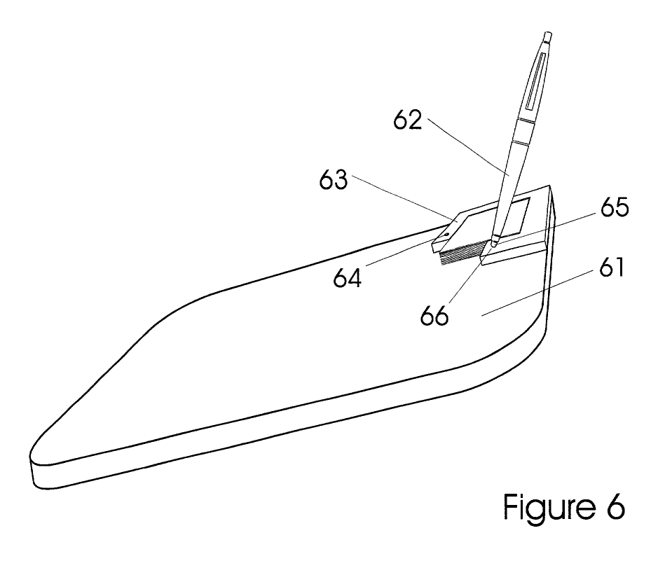

Finally, FIG. 6 illustrates how a writing implement such as a pen may be accommodated in a holding position. Substrate mouse pad 61 and writing pen 62 are held together by way of raised ridge 63 which has therein pen holding holes 64 and 66. The pen tip 65 is pushed into the raised ridge hole 66. The pliable nature of the material from which the raised ridge is formed allows the pen to penetrate and be held there within the pen holding hole. Devices of these inventions therefore further combine functionality relating to pen storage with writing and mousing actions in a single device. As the writing task requires a pen, considerable advantage is gained when one is not left with first finding a pen. Pens which are kept in close proximity to pads are of great use when a writing task comes to hand. Thus, holes well placed in the raised ridge as described herein tend to facilitate the overall objectives of the invention. Writing actions made in conjunction with computer mouse actions are more easily made when users employ devices of these inventions.

One will now fully appreciate how a mouse pad may be arranged to cooperate and be integrated with a note pad. Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1. Apparatus combination of a mouse pad and writing pad holder, the combination comprising the elements:
a) a substrate element; and
b) a raised ridge element,
said substrate element having a top surface and a bottom surface and a substantially rectangular periphery of four edges and four corners,
said raised ridge element being substantially smaller than said substrate element having at least three sides and further being disposed in one substrate corner and affixed thereto whereby a receiving cavity is formed by a portion of the substrate top surface and sides of the raised ridge element said receiving cavity being operable for receiving and holding therein a pad of writing paper.

2. Apparatus of claim 1, said raised ridge further defined as being comprised of four edges two of which are parallel to each other and perpendicular to the remaining two, two of said four edges being aligned and colinear with said substrate edges, two of said four edges extending inwardly away from said substrate edges.

3. Apparatus of claim 2, said two edges extending inwardly being of different lengths one extending downwardly away from a substrate top edge being approximately twice the length of the inwardly extending side from substrate side edge to form an open region at a corner of said receiving cavity.

4. Apparatus of claim 2, including at least one small hole forming a pen holding means, said hole being made into pliable material from which the raised ridge is formed.

5. Apparatus of claim 1, said substrate being formed of a rubber based material commonly known by the tradename ‘Neoprene’.

6. Apparatus of claim 2, said substrate top surface is operable for actions relating to the operation of a computer mouse, bottom surface is operable for providing a non-skid function with respect to a smooth surface upon which the substrate is placed.

8. Apparatus of claim 1 said substrate and raised ridge is molded together as a single piece compound device.

9. Apparatus of claim 1, said raised ridge being affixed to said top surface with an adhesive.

10. Apparatus of claim 1, top surface having indicia in a lower left corner whereby a pleasing visual appearance is attained by the balance of the indicia and the receiving cavity located in a corner opposite and diagonally opposed to said lower left corner.

11. Apparatus of claim 4, said at least one small hole includes two hole one each on either of two raised ridge sides whereby an ambidextrous arrangement is realized.

12. Apparatus of claim 2, sides form a receiving cavity having a square cross section.

13. Apparatus of claim 12, said square cross section is between 2 to 3 inches on a side.

14. Apparatus of claim 3, said open region provides access to the corners of sheets of paper held in the cavity.
